(19) United States
(12) Patent Application Publication
(10) Pub. No.: US 2015/0026256 A1
(43) Pub. Date: Jan. 22, 2015

(54) ALERT NOTIFICATION SYNCHRONIZATION ACROSS DATA PROCESSING DEVICES

(71) Applicant: NVIDIA Corporation, Santa Clara, CA (US)

(72) Inventor: Vinay Varma, Secunderabad (IN)

(21) Appl. No.: 13/944,890

(22) Filed: Jul. 18, 2013

(51) Int. Cl. H04L 29/08

(52) U.S. Cl. CPC H04L 67/1095
USPC 709/204

(57) ABSTRACT

A method includes executing an instance of a process on each of a data processing device and one or more other data processing device(s), and setting up a Personal Area Network (PAN) associated with a user through registering the one or more other data processing device(s) with the data processing device based on an identifier thereof utilizing a first communication link of the PAN to enable data communication therebetween. The method also includes transmitting, through the execution of the instance of the process, a notification of an alert of an incoming communication to the one or more other data processing device(s) from the one or more other data processing device(s) to the data processing device through a second communication link of the PAN following the setting up of the PAN to enable the user be apprised of the alert through the data processing device.

### FIELD OF TECHNOLOGY

This disclosure relates generally to data processing devices and, more particularly, to alert notification synchronization across data processing devices.

### BACKGROUND

A data processing device (e.g., a mobile phone, a tablet) may receive an alert of incoming communication (e.g., a phone call, a voice message, a text message, an e-mail, a desktop notification) thereto. For example, a mobile phone may have a sound associated with a new text message thereto. A user of the mobile phone may set the mobile phone to operate in a silent mode thereof. Now, when the mobile phone receives an important text message, the user may not be aware of the reception thereof. The unawareness of the user may lead to undesirable repercussions.

### SUMMARY

Disclosed are a method, a device and/or a system of alert notification synchronization across data processing devices.

In one aspect, a method includes executing an instance of a process on each of a data processing device and one or more other data processing device(s), and setting up a Personal Area Network (PAN) associated with a user through registering the one or more other data processing device(s) with the data processing device based on an identifier thereof utilizing a first communication link of the PAN to enable data communication therebetween. The method also includes transmitting, through the execution of the instance of the process, a notification of an alert of an incoming communication to the one or more other data processing device(s) from the one or more other data processing device(s) to the data processing device through a second communication link of the PAN following the setting up of the PAN to enable the user be apprised of the alert through the data processing device. The second communication link is a same communication link as the first communication link or different from the first communication link.

In another aspect, a non-transitory medium, readable through a data processing device and one or more other data processing device(s) and including instructions embodied therein that are executable through the data processing device and the one or more other data processing device(s), is disclosed. The non-transitory medium includes instructions to execute an instance of a process on each of the data processing device and the one or more other data processing device(s), and instructions to enable setting up a PAN associated with a user through registering the one or more other data processing device(s) with the data processing device based on an identifier thereof utilizing a first communication link of the PAN to enable data communication therebetween.

The non-transitory medium also includes instructions to transmit, through the execution of the instance of the process, a notification of an alert of an incoming communication to the one or more other data processing device(s) from the one or more other data processing device(s) to the data processing device through a second communication link of the PAN following the setting up of the PAN to enable the user be apprised of the alert through the data processing device. The second communication link is a same communication link as the first communication link or different from the first communication link.

In yet another aspect, a system includes a data processing device, and one or more other data processing device(s). Each of the data processing device and the one or more other data processing device(s) executes an instance of a process thereon. A PAN associated with a user is configured to be set up through registering the one or more other data processing device(s) with the data processing device based on an identifier thereof utilizing a first communication link of the PAN to enable data communication therebetween. The execution of the instance of the process is configured to enable transmission of a notification of an alert of an incoming communication to the one or more other data processing device(s) from the one or more other data processing device(s) to the data processing device through a second communication link of the PAN following the setting up of the PAN to enable the user be apprised of the alert through the data processing device.

The second communication link is a same communication link as the first communication link or different from the first communication link.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data communication system, according to one or more embodiments.

FIG. 2 is a schematic view of data processing devices of the data communication system of FIG. 1 with corresponding Near Field Communication (NFC) circuits.

FIG. 3 is a schematic view of notification synchronization in an example data communication system of FIG. 1.

FIG. 4 is a schematic view of an external data processing device configured to perform processing on an alert notification following transmission thereof between data processing devices of the data communication system of FIG. 1, according to one or more embodiments.

FIG. 5 is a schematic view of another implementation of the external data processing device of FIG. 4, where the external data processing device is configured to perform processing on the alert notification prior to the transmission thereof between the data processing devices of the data communication system of FIG. 1.

FIG. 6 is a schematic view of an example user interface provided by an application and/or an operating system executing on a data processing device of the data communication system of FIG. 1.

FIG. 7 is a process flow diagram detailing the operations involved in alert notification synchronization across data processing devices of the data communication system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of alert notification synchronization across data processing devices. Although the present embodiments have been described with reference to specific example embodiments, it will be evident that various modifications and changes may be made to these embodiments without departing from the broader spirit and scope of the various embodiments.

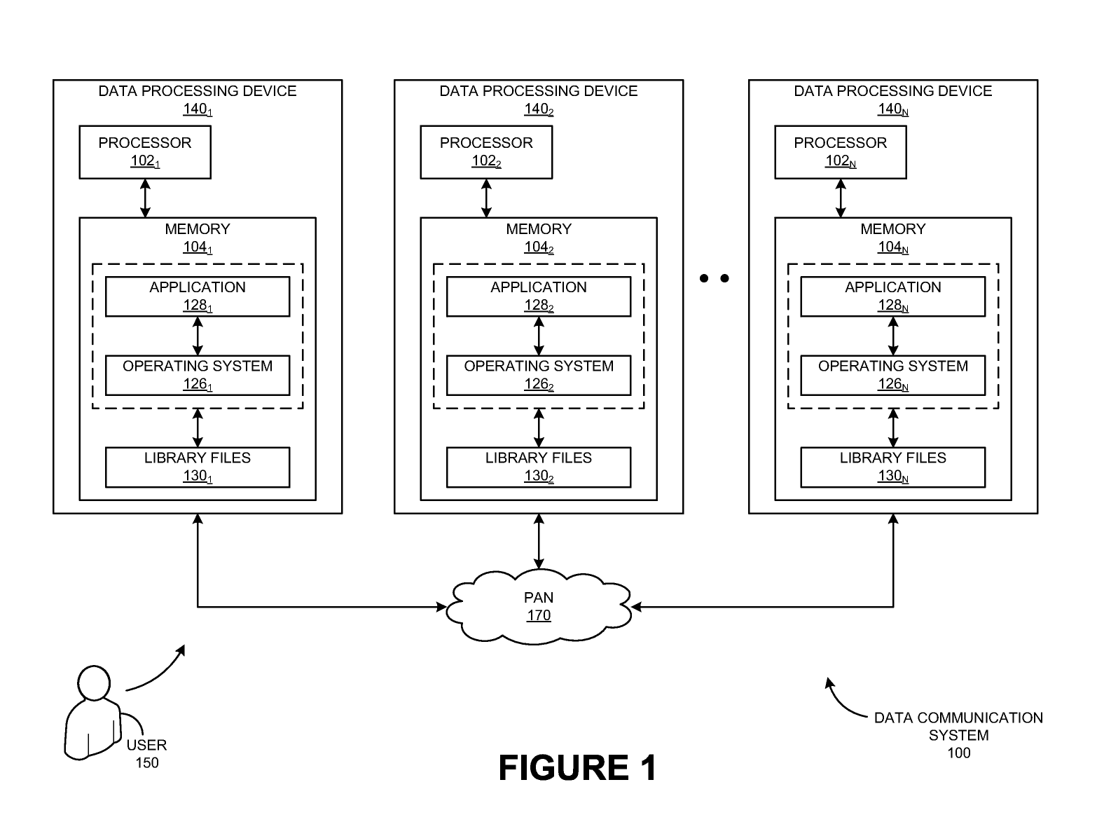

FIG. 1 shows a data communication system 100 configured to enable synchronization of notification of incoming communication to one or more data processing devices 140_{2-N} between the one or more data processing devices 140_{2-N} and a data processing device 140₁, according to one or more embodiments. In one or more embodiments, the aforementioned data processing devices 140_{1-N} may share a common user 150 therebetween. For example, one data processing device 140₁ may be a tablet and another data processing device 140₂ may be a mobile phone. Alternately, both data processing device 140₁ and data processing device 140₂ may be mobile phones or tablets. Other forms of data processing devices 140_{1-N} are within the scope of the exemplary embodiments discussed herein.

In one or more embodiments, each data processing device 140_{1-N} may include a processor 102_{1-N} (e.g., a Central Processing Unit (CPU) and/or a Graphics Processing Unit (GPU)) communicatively coupled to a memory 104_{1-N} (e.g., a volatile memory and/or a non-volatile memory); memory 104_{1-N} may include storage locations configured to be addressable through processor 102_{1-N}. In one or more embodiments, each data processing device 140_{1-N} may execute an operating system 126_{1-N} thereon. In one or more embodiments, operating system 126₁ of data processing device 140₁ may be different from operating system 126₂ of another data processing device 140₂. In one or more other embodiments, two data processing devices (e.g., data processing device 140₁ and data processing device 140₂) may share a same operating system.

In one or more embodiments, each data processing device 140_{1-N} may execute an instance of an application 128_{1-N} thereon. FIG. 1 shows operating system 126_{1-N} and application 128_{1-N} as being stored in memory 104_{1-N}. In one or more embodiments, application 128_{1-N} may have a set of instructions associated with the notification synchronization discussed above. In one or more embodiments, for the aforementioned purpose, a non-transitory machine-readable medium including but not limited to a Compact Disc (CD), a Digital Video Disc (DVD) and a Blu-ray Disc® may include appropriate instructions embodied therein that can be executable through each data processing device 140_{1-N}; application 128_{1-N} may, therefore, be loaded onto each data processing device 140_{1-N}.

Alternately, the abovementioned set of instructions may be downloaded from, for example, the Internet and installed on each data processing device 140_{1-N}. In one or more embodiments, data processing device 140₁ may be coupled to another data processing device 140₂ through a short-range wired or wireless communication link such as a Personal Area Network (PAN) 170 (e.g., based on Wi-Fi Direct™, Bluetooth®, Near Field Communication (NFC)). In one or more embodiments, in case of data processing device 140₁ and data processing device 140₂ having dissimilar operating systems, application 128₁ and/or application 128₂ may be packaged with appropriate library files 130₁₋₂ to enable compatibility of data communication therebetween; FIG. 1 shows both application 128₁ and application 128₂ being packaged with library files 130₁ and library files 130₂ respectively.

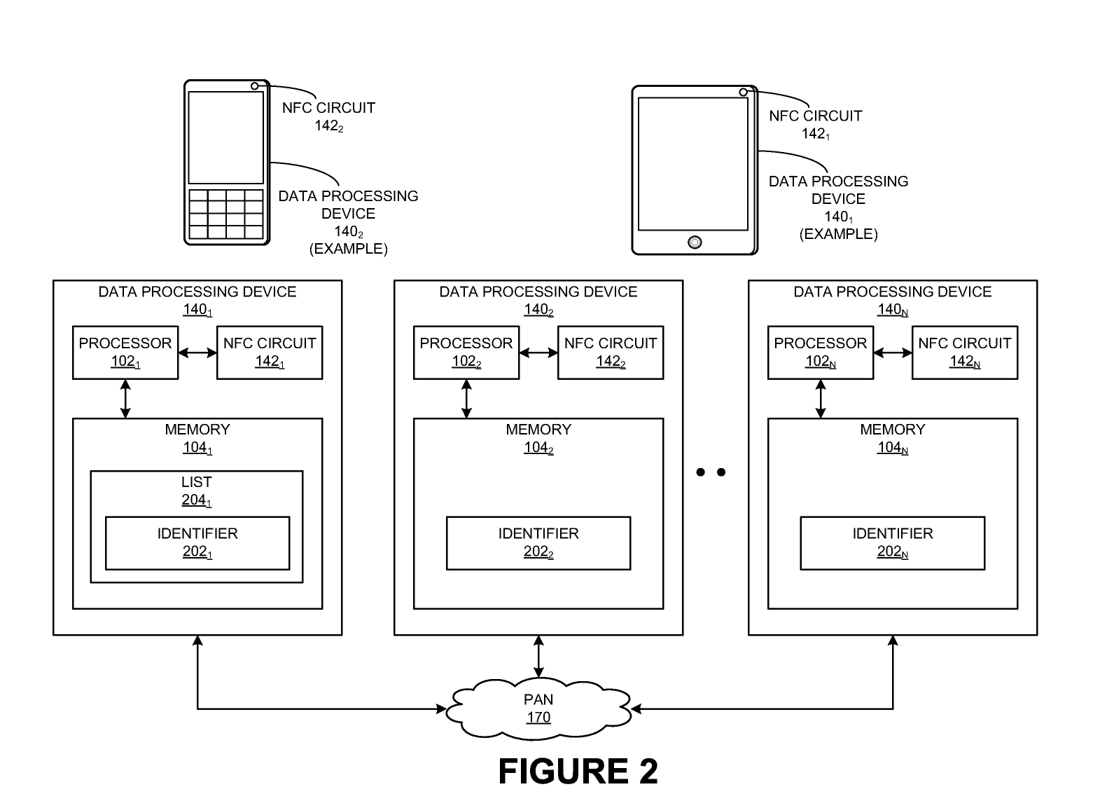

In one or more embodiments, data processing device 140₂ may first be registered with data processing device 140₁ prior to enabling the notification synchronization. In one example embodiment, data processing device 140₂ may be paired with data processing device 140₁ through an NFC based communication link. For the aforementioned purpose, each data processing device 140_{1-N} may be NFC enabled. FIG. 2 shows data processing device 140₁ and data processing device 140₂ with corresponding NFC circuit 142₁ and NFC circuit 142₂ respectively.

As part of the pairing process, data processing device 140₁ and data processing device 140₂ may be brought in close proximity to one another; an identifier 202₂ of data processing device 140₂ may be read through NFC circuit 142₁ of data processing device 140₁; identifier 202₂ may be hard-coded into NFC circuit 142₂ of data processing device 140₂. Identifier 202₂ may then be stored in memory 104₁ of data processing device 140₁ in a list 204₁ of data processing devices 140_{2-N} configured to communicate with data processing device 140₁. One or more other data processing devices 140_{3-N} may also be paired with data processing device 140₁ in a similar manner to enable identifiers 202_{3-N} thereof being stored in list 204₁. Identifiers 202_{2-N} may enable identification of data processing devices 140_{2-N} when within range of communication of data processing device 140₁.

It should be noted that the communication link utilized for registration (e.g., NFC, Bluetooth®) may be different from the communication link utilized for notification synchronization (Wi-Fi Direct™). Alternately, the same communication link (e.g., Bluetooth®) may be employed for both the registration and the notification synchronization. Also, the abovementioned pairing process is merely for example purposes; other forms of registration are within the scope of the exemplary embodiments.

In one or more embodiments, through the registration of data processing devices 140_{2-N} with data processing device 140₁, user 150 may set up a personal network to receive notifications of incoming alerts to any data processing device 140_{2-N} registered with data processing device 140₁ at data processing device 140₁. It should be noted that in several scenarios, merely one data processing device 140₂ may be registered with data processing device 140₁. In other exemplary scenarios, multiple data processing devices 140_{2-N} may be registered with data processing device 140₁. Considering one such scenario of a mobile phone (data processing device 140₂) and a laptop computer (data processing device 140₃) being registered with a tablet (data processing device 140₁) to form a personal network associated with user 150, exemplary embodiments provide for receiving notifications of incoming alerts to the mobile phone (data processing device 140₂) and the laptop computer (data processing device 140₃) on the tablet (data processing device 140₁). Exemplary embodiments may also enable user 150 respond to the incoming alerts through the tablet (data processing device 140₁).

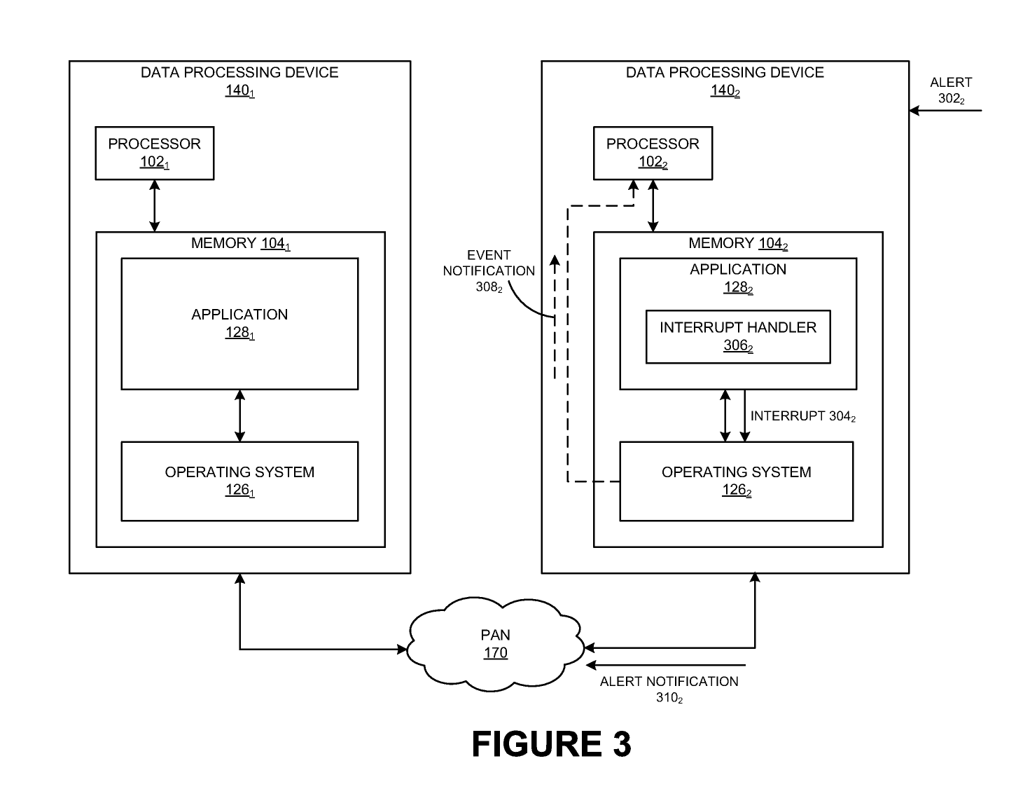

In one or more embodiments, the execution of application 128₁ may enable data processing device 140₁ detect the presence of other data processing devices 140_{2-N} registered therewith based on identifiers 202_{2-N}. FIG. 3 shows notification synchronization in an example data communication system 100. Once a data processing device 140₂ registered with data processing device 140₁ receives an incoming alert 302₂ (e.g., associated with a phone call, a voice message, a text message, a desktop notification, a browser notification), application 128₂ executing on data processing device 140₂ may be configured to generate an interrupt 304₂ to operating system 126₂ thereof. In one or more embodiments, application 128₂ interfaced with operating system 126₂ or operating system 126₂ may include an interrupt handler 306₂ to handle said interrupt 304₂. FIG. 3 shows interrupt handler 306₂ as being implemented in application 128₂. Operating system 126₂ may then generate an event notification 308₂ that is detected through processor 102₂. Once alert 302₂ is detected through processor 102₂ based on event notification 308₂, application 128₂ may enable transmission of an appropriate alert notification 310₂ through processor 102₂ to data processing device 140₁. Other forms of detection of alert 302₂ through processor 102₂ are within the scope of the exemplary embodiments discussed herein.

In one or more embodiments, application 128₂ may enable transmission of alert notification 310₂ to data processing device 140₁ through processor 102₂ in a universal format such as text or a browser update; the universal format may be compatible with multiple operating systems. In one or more embodiments, as application 128₂ may be packaged with appropriate library files 130₂, data related to alert notification 310₂ may be converted to a format compatible with operating system 126₁ of data processing device 140₁ prior to transmission thereof. In certain scenarios, real-time reception of alert notification 310₂ at data processing device 140₁ may not be required. For example, user 150 may receive a text message related to an online transaction receipt; here, real-time reception may not be crucial.

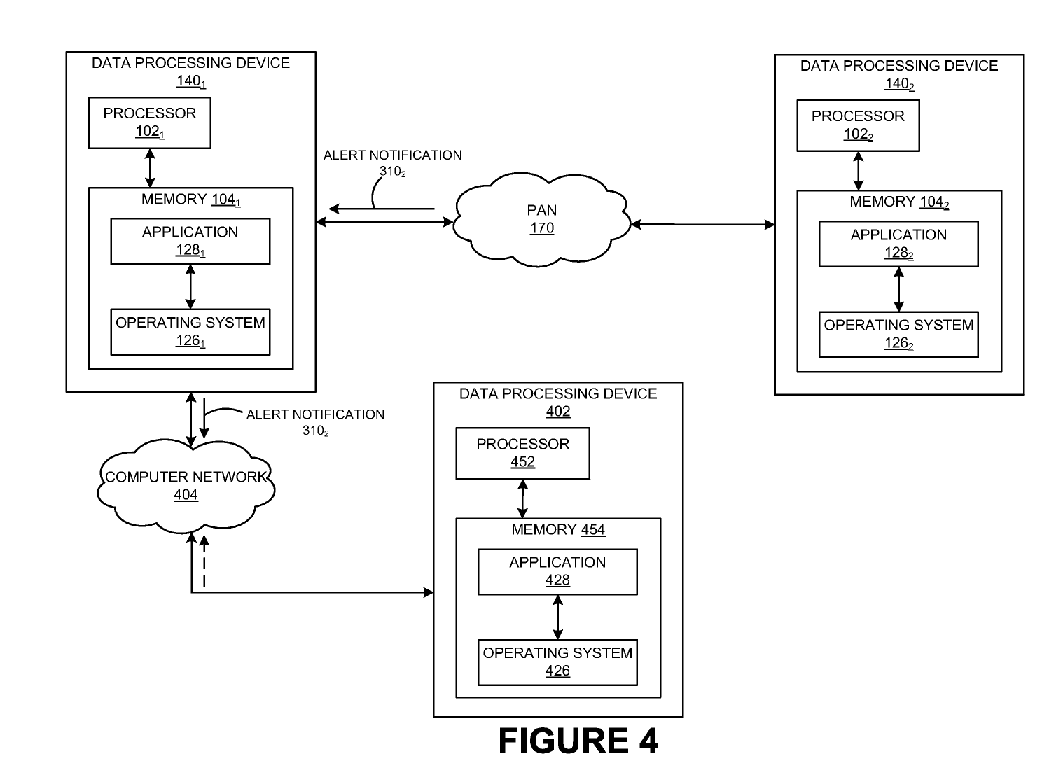

FIG. 4 shows an external data processing device 402 configured to perform processing on alert notification 310₂ following transmission thereof from data processing device 140₂ to data processing device 140₁. Upon receipt of alert notification 310₂ at data processing device 140₁, data processing device 140₁ may be configured to forward (e.g., through processor 102₁) alert notification 310₂ to data processing device 402 communicatively coupled thereto following determination of incompatibility of alert notification 310₂ with operating system 126₁. Data processing device 402 may be configured to convert alert notification 310₂ to a format compatible with operating system 126₁ of data processing device 140₁. In one example embodiment, data processing device 402 (e.g., a server) may be communicatively coupled to data processing device 140₁ through a computer network 404 (e.g., Internet, a Local Area Network (LAN), a Wide Area Network (WAN)). In another example embodiment, data processing device 402 may be one of data processing devices 140_{3-N}. It should also be noted that the conversion discussed herein may be performed at data processing device 140₁ utilizing library files 130₁ stored therein.

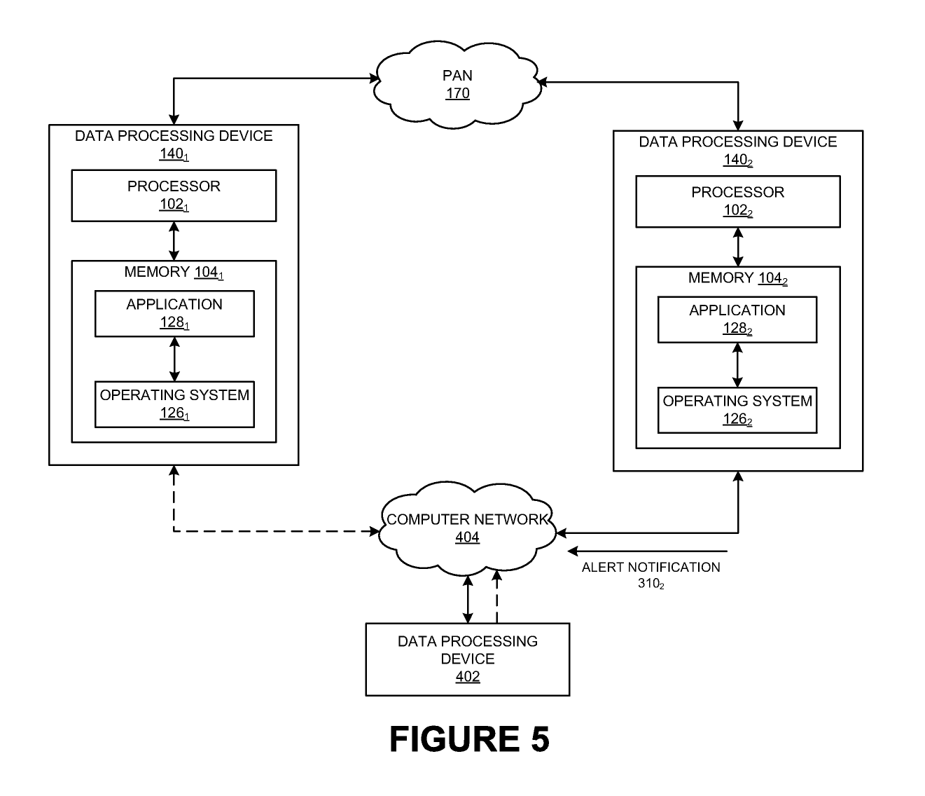

FIG. 5 shows another implementation of data processing device 402 as being configured to perform processing on alert notification 310₂ prior to transmission thereof from data processing device 140₂ to data processing device 140₁. In one example embodiment, processor 102₂ of data processing device 140₂ may be configured to poll operating system 126₁ of data processing device 140₁ through processor 102₁ to determine the abovementioned incompatibility. Upon determination of the incompatibility, data processing device 140₂ may forward alert notification 310₂ to data processing device 402 through processor 102₂ to enable conversion of alert notification 310₂ to a format compatible with operating system 126₁ of data processing device 140₁ at data processing device 402. Here, data processing device 402 (e.g., a server) may be communicatively coupled to data processing device 140₂ through computer network 404 (e.g., Internet, a LAN, a WAN).

With regard to FIG. 5, it should be noted that data processing device 402 may transmit alert notification 310₂ in the converted format back to data processing device 140₂ to, in turn, be transmitted to data processing device 140₁. Alternately, data processing device 402 may directly transmit alert notification 310₂ in the converted format to data processing device 140₁. In this case, data processing device 140₁ may also be communicatively coupled to data processing device 402 through computer network 404.

It should also be noted that communication between data processing device 140₁ and/or data processing device 140₂ and data processing device 402 may be limited to obtaining the appropriate library files therefrom. The conversion may then occur at data processing device 140₁ and/or data processing device 140₂ following loading of the library files thereon.

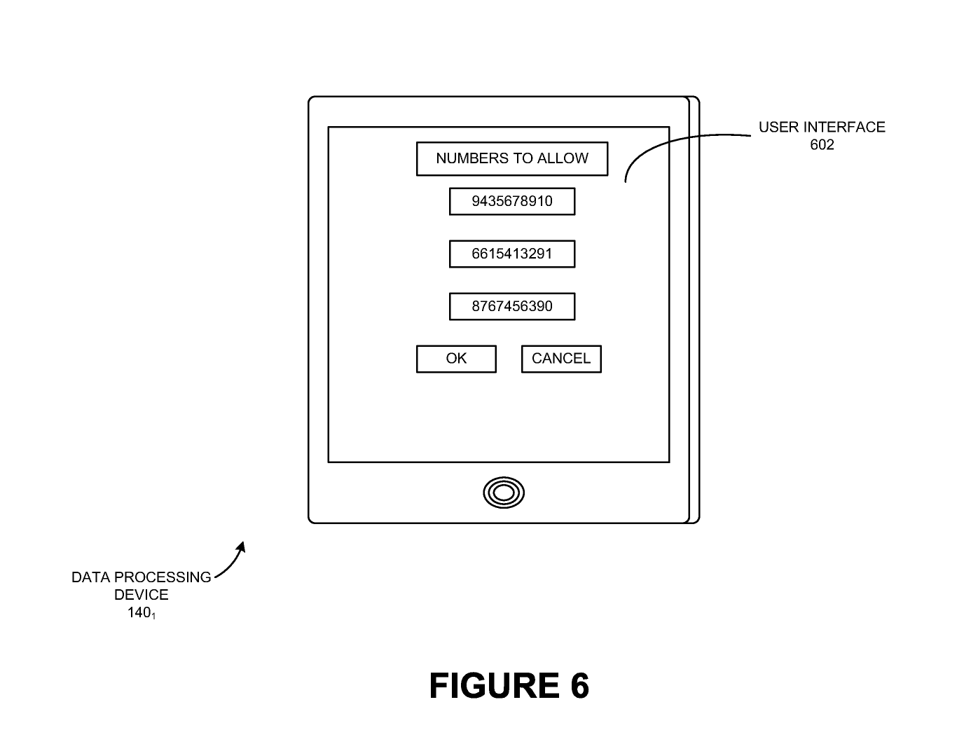

In one or more embodiments, user 150 may choose to only receive important alert notifications. For example, user 150 may wish to only receive alert notification(s) 310₂ of text messages associated with two phone numbers. Through a user interface provided by application 128₁/operating system 126₁ and/or application 128₂/operating system 126₂, user 150 may opt for receiving alert notification(s) 310₂ solely from the two phone numbers. FIG. 6 shows an example user interface 602 provided by application 128₁ and/or operating system 126₁ at data processing device 140₁.

It should be noted that the discarding of alert notification(s) 310₂ other than those preferred by user 150 may occur at data processing device 140₂ (e.g., through processor 102₂), data processing device 140₁ (e.g., through processor 102₁) or at data processing device 402. As shown in FIG. 4, data processing device 402 may include a processor 452 communicatively coupled to a memory 454. An application 428 and an operating system 426 may execute on data processing device 402; FIG. 4 shows application 428 and operating system 426 as being stored in memory 454. Through a user interface (analogous to user interface 602) provided by application 428 and/or operating system 426, data processing device 402 may be configured to discard alert notification(s) 310₂ not desired by user 150. Alternately, the user interface at data processing device 402 may not be required; data processing device 402 may be configured to discard alert notification(s) 310₂ solely based on configuration(s) through user interface 602 (or, a user interface provided by application 128₂ and/or operating system 126₂).

In one or more embodiments, depending on alert notification 310₂ transmitted to data processing device 140₁, user 150 may be able to respond to alert notification 310₂ through data processing device 140₁. For example, the transmission of alert notification 310₂ to data processing device 140₁ may open up an interface for user 150 to appropriately respond.

User 150 may be in a room with data processing device 140₁ and data processing device 140₂ may be located in another room. Alert notification 310₂ of incoming communication to data processing device 140₂ may be transmitted to data processing device 140₁, thereby enabling user 150 to respond through data processing device 140₁. In another scenario, data processing device 140₂ may be in a silent mode of operation thereof. User 150 may opt to receive important alert notification(s) 310₂ of incoming communication to data processing device 140₂ at data processing device 140₁. Thus, user 150 may enjoy the benefits of the silent mode of operation without missing out on important alert notification(s) 310₂.

It should be noted that applications 128_{1-N} may not be the sole way to implement the concepts associated with the example embodiments discussed herein. For example, applications 128_{1-N} may be subsets of processes executing on data processing devices 140_{1-N} that enable the concepts discussed herein.

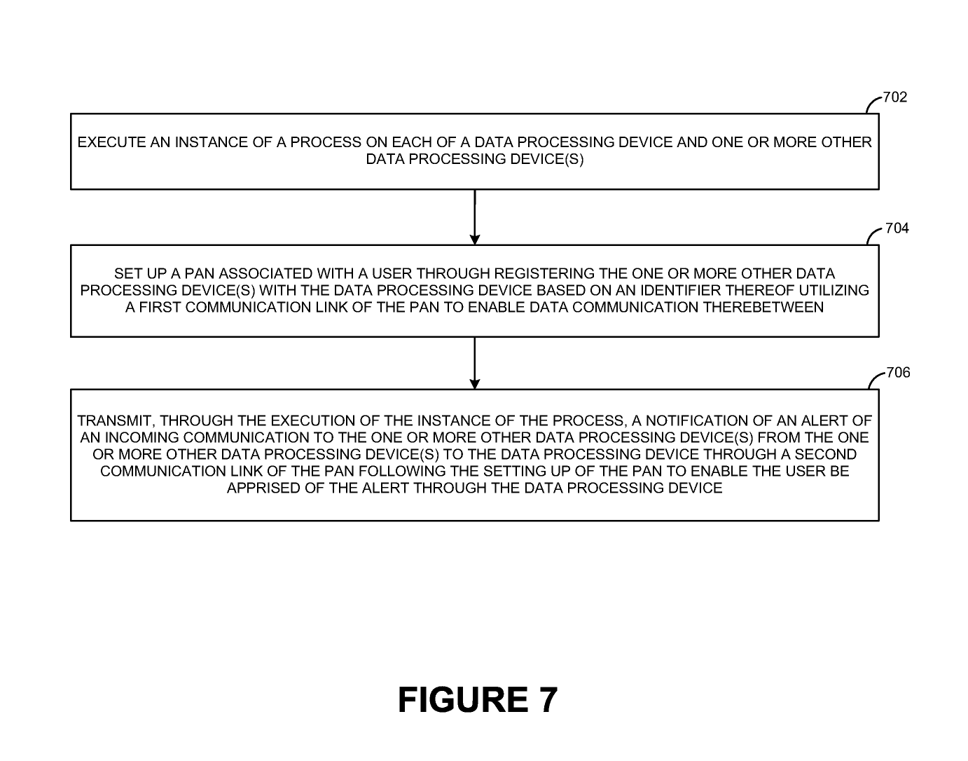

FIG. 7 shows a process flow diagram detailing the operations involved in alert notification synchronization across data processing devices, according to one or more embodiments. In one or more embodiments, operation 702 may involve executing an instance of a process on each of a data processing device 140₁ and one or more other data processing device(s) 140_{2-N}. In one or more embodiments, operation 704 may involve setting up PAN 170 associated with user 150 through registering the one or more other data processing device(s) 140_{2-N} with data processing device 140₁ based on an identifier 202_{2-N} thereof utilizing a first communication link of PAN 170 to enable data communication therebetween.

In one or more embodiments, operation 706 may then involve transmitting, through the execution of the instance of the process, a notification of an alert (e.g., alert notification 310₂) of an incoming communication to the one or more other data processing device(s) 140_{2-N} from the one or more other data processing device(s) 140_{2-N} to data processing device 140₁ through a second communication link of PAN 170 following the setting up of PAN 170 to enable user 150 be apprised of the alert through data processing device 140₁. In one or more embodiments, the second communication link may be a same communication link as the first communication link or different from the first communication link.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a data processing device 140_{1-N}). Accordingly, the specification and drawings are to be regarded in an illustrative rather than a restrictive sense.

What is claimed is:

1. A method comprising:
executing an instance of a process on each of a data processing device and at least one another data processing device;
setting up a Personal Area Network (PAN) associated with a user through registering the at least one another data processing device with the data processing device based on an identifier thereof utilizing a first communication link of the PAN to enable data communication therebetween; and
transmitting, through the execution of the instance of the process, a notification of an alert of an incoming communication to the at least one another data processing device from the at least one another data processing device to the data processing device through a second communication link of the PAN following the setting up of the PAN to enable the user be apprised of the alert through the data processing device, the second communication link being one of: a same communication link as the first communication link and different from the first communication link.

2. The method of claim 1, further comprising packaging at least one of the data processing device and the at least one another data processing device with appropriate library files to enable conversion of the notification of the alert to a format compatible with an operating system executing on the data processing device at the at least one of the data processing device and the at least one another data processing device.

3. The method of claim 1, comprising transmitting the notification of the alert in a universal format compatible with an operating system executing on the data processing device and at least one operating system executing on the at least one another data processing device.

4. The method of claim 1, further comprising at least one of:
forwarding the notification of the alert to an external data processing device for conversion thereof to a format compatible with an operating system executing on the data processing device from one of: the data processing device following reception of the notification of the alert and the at least one another data processing device after determination of incompatibility between a format of the notification of the alert and the operating system executing on the data processing device, the external data processing device being one of: a device communicatively coupled to at least one of: the data processing device through a computer network and the at least one another data processing device and a data processing device of the at least one another data processing device; and
providing, through the execution of the instance of the process, an interface at the data processing device for the user to respond to the notification of the alert.

5. The method of claim 1, further comprising:
solely transmitting the notification of the alert when the notification of the alert corresponds to a configuration predefined through a user interface of at least one of: at least one of the instance of the process and an operating system executing on the data processing device, at least one of the instance of the process and at least one operating system executing on the at least one another data processing device and at least one of a process and an operating system executing on an external data processing device communicatively coupled to at least one of the data processing device and the at least one another data processing device through a computer network; and
discarding the notification of the alert when the notification of the alert does not correspond to the predefined configuration.

6. The method of claim 1, comprising executing the instance of the process as part of an instance of an application executing on the each of the data processing device and the at least one another data processing device.

7. The method of claim 4, further comprising polling, from the at least one another data processing device, the operating system executing on the data processing device through a processor of the data processing device to determine the incompatibility between the format of the notification of the alert and the operating system executing on the data processing device.

8. A non-transitory medium, readable through a data processing device and at least one another data processing device and including instructions embodied therein that are executable through the data processing device and the at least one another data processing device, comprising:
instructions to execute an instance of a process on each of the data processing device and the at least one another data processing device;
instructions to enable setting up a PAN associated with a user through registering the at least one another data processing device with the data processing device based on an identifier thereof utilizing a first communication link of the PAN to enable data communication therebetween; and
instructions to transmit, through the execution of the instance of the process, a notification of an alert of an incoming communication to the at least one another data processing device from the at least one another data processing device to the data processing device through a second communication link of the PAN following the setting up of the PAN to enable the user be apprised of the alert through the data processing device, the second communication link being one of: a same communication link as the first communication link and different from the first communication link.

9. The non-transitory medium of claim 8, comprising instructions to transmit the notification of the alert in a universal format compatible with an operating system executing on the data processing device and at least one operating system executing on the at least one another data processing device.

10. The non-transitory medium of claim 8, further comprising at least one of:
instructions to forward the notification of the alert to an external data processing device for conversion thereof to a format compatible with an operating system executing on the data processing device from one of: the data processing device following reception of the notification of the alert and the at least one another data processing device after determination of incompatibility between a format of the notification of the alert and the operating system executing on the data processing device, the external data processing device being one of: a device communicatively coupled to at least one of: the data processing device through a computer network and the at least one another data processing device and a data processing device of the at least one another data processing device; and
instructions to provide, through the execution of the instance of the process, an interface at the data processing device for the user to respond to the notification of the alert.

11. The non-transitory medium of claim 8, further comprising:
instructions to solely transmit the notification of the alert when the notification of the alert corresponds to a configuration predefined through a user interface of at least one of: at least one of the instance of the process and an operating system executing on the data processing device, at least one of the instance of the process and at least one operating system executing on the at least one another data processing device and at least one of a process and an operating system executing on an external data processing device communicatively coupled to at least one of the data processing device and the at least one another data processing device through a computer network; and
instructions to discard the notification of the alert when the notification of the alert does not correspond to the predefined configuration.

12. The non-transitory medium of claim 8, comprising instructions to execute the instance of the process as part of an instance of an application executing on the each of the data processing device and the at least one another data processing device.

13. The non-transitory medium of claim 10, further comprising instructions to poll, from the at least one another data processing device, the operating system executing on the data processing device through a processor of the data processing device to determine the incompatibility between the format of the notification of the alert and the operating system executing on the data processing device.

14. A system comprising:
a data processing device; and
at least one another data processing device, each of the data processing device and the at least one another data processing device executing an instance of a process thereon,
wherein a PAN associated with a user is configured to be set up through registering the at least one another data processing device with the data processing device based on an identifier thereof utilizing a first communication link of the PAN to enable data communication therebetween, and
wherein the execution of the instance of the process is configured to enable transmission of a notification of an alert of an incoming communication to the at least one another data processing device from the at least one another data processing device to the data processing device through a second communication link of the PAN following the setting up of the PAN to enable the user be apprised of the alert through the data processing device, the second communication link being one of: a same communication link as the first communication link and different from the first communication link.

15. The system of claim 14, wherein at least one of: the data processing device and the at least one another data processing device is packaged with appropriate library files to enable conversion of the notification of the alert to a format compatible with an operating system executing on the data processing device at the at least one of the data processing device and the at least one another data processing device.

16. The system of claim 14, wherein the notification of the alert is transmitted in a universal format compatible with an operating system executing on the data processing device and at least one operating system executing on the at least one another data processing device.

17. The system of claim 14, wherein at least one of:
the notification of the alert is forwarded to an external data processing device for conversion thereof to a format compatible with an operating system executing on the data processing device from one of: the data processing device following reception of the notification of the alert and the at least one another data processing device after determination of incompatibility between a format of the notification of the alert and the operating system executing on the data processing device, the external data processing device being one of: a device communicatively coupled to at least one of: the data processing device through a computer network and the at least one another data processing device and a data processing device of the at least one another data processing device, and
the execution of the instance of the process is configured to provide an interface at the data processing device for the user to respond to the notification of the alert.

18. The system of claim 14, wherein:
the notification of the alert is solely transmitted when the notification of the alert corresponds to a configuration predefined through a user interface of at least one of: at least one of the instance of the process and an operating system executing on the data processing device, at least one of the instance of the process and at least one operating system executing on the at least one another data processing device and at least one of a process and an operating system executing on an external data processing device communicatively coupled to at least one of the data processing device and the at least one another data processing device through a computer network, and
the notification of the alert is discarded when the notification of the alert does not correspond to the predefined configuration.

19. The system of claim 14, wherein the instance of the process is part of an instance of an application executing on the each of the data processing device and the at least one another data processing device.

20. The system of claim 17, wherein the at least one another data processing device is configured to poll the operating system executing on the data processing device through a processor of the data processing device to determine the incompatibility between the format of the notification of the alert and the operating system executing on the data processing device.
